(19) United States
(12) Patent Application Publication
(10) Pub. No.: US 2026/0178422 A1
(43) Pub. Date: Jun. 25, 2026

(54) Accelerating and Improved Fairness for Semaphores

(71) Applicant: Advanced Micro Devices, Inc., Santa Clara, CA (US)

(72) Inventor: Karl Peter Brummel, Fort Collins, CO (US)

(73) Assignee: Advanced Micro Devices, Inc., Santa Clara, CA (US)

(21) Appl. No.: 18/987,553

(22) Filed: Dec. 19, 2024

(51) Int. Cl. G06F 9/52; G06F 9/46

(52) U.S. Cl. CPC G06F 9/526; G06F 9/461

(57) ABSTRACT

Accelerating and improved fairness for semaphores is described. In one or more implementations, a computing device includes a plurality of cores and one or more computing resources, exclusive access to which is limited, e.g., to a single core at a time. In one or more implementations, the computing device also includes core selection circuitry configured to identify a first core from the plurality of cores exclusively accessing the one or more limited computing resources and configured to instruct a second core from the plurality of cores to release the exclusive access of the first core to the one or more computing resources.

### BACKGROUND

In a computing system having multiple processors or cores, the cores may share shared system resources such as buffers. A semaphore may be maintained (or owned) in one of the processors or cores to regulate access to these shared resources. This semaphore indicates that the owning core has access to the shared resource and that other cores do not, and the semaphore is released when the owning core has finished with the shared resource to allow other cores to obtain the semaphore and access the shared resource.

### BRIEF DESCRIPTION OF THE DRAWINGS

FIG. 1 is a block diagram of a processing system configured to execute one or more applications, in accordance with one or more implementations.

FIG. 2 is a diagram of a cache arrangement of the cores of a processing system, in accordance with one or more implementations.

FIG. 3 is a diagram of a cache arrangement of the cores of a processing system illustrating an imbalance in acquiring the semaphore.

FIG. 4 is a flow chart showing how a semaphore release is detected and a releasing core is selected, in accordance with one or more implementations.

FIG. 5 is a diagram of a cache arrangement of the cores of a processing system, in accordance with one or more implementations.

FIG. 6 is a graph showing an example of acquisition of a semaphore in a computer system when a core holding a semaphore is allowed to release the semaphore.

FIG. 7 is a graph showing an example of acquisition of a semaphore in a computer system when a remote core different from the core holding the semaphore is selected to release the semaphore, in accordance with one or more implementations.

FIG. 8 is a graph showing when each core has acquired a semaphore a number of times, in accordance with one or more implementations.

### DETAILED DESCRIPTION

In computing systems with multiple cores and a multilayered cache hierarchy, a semaphore may be used to control access to shared resources such as buffers. Broadly, a semaphore is a synchronization mechanism used to control access to shared resources by multiple processes, threads, and/or cores, such as in a concurrent execution environment. A semaphore helps avoid conflicts or race conditions when multiple threads, processes, and/or cores attempt to access shared resources substantially simultaneously. Examples of semaphores include counting semaphores, which allow an arbitrary resource count, and binary semaphores, which are restricted to the values of 0 and 1 (or locked/unlocked, unavailable/available, or similar). A semaphore may be implemented as a variable or abstract data type in software, such as for a multi-tasking operating system. For instance, a locking variable may be used to control access to the semaphore, and the locking variable may be manipulated using a test-and-set-lock command.

In a multi core system, a single core requiring access to such a shared resource will acquire ownership of the semaphore, providing it to access the shared resource exclusively. Cores without the semaphore may be prevented from accessing those shared resources when the semaphore is not assigned to them. When the owning core finishes using the shared resource, the semaphore is released from the owning core and can be reassigned to a different core, allowing each core to access the shared resources at some point during operation. In other words, a semaphore provides a core exclusive access to a shared resource, such as during parallel processing or for certain computing benchmarks when multiple cores are requesting access to the shared resource substantially in parallel. Exclusive access refers to access provided to an individual entity of a system (e.g., a core of a system) to the exclusion of other such entities (e.g., other cores of the system).

A goal of some computing benchmarks, for instance, is to allow each core of a multi-core architecture to access a shared resource a certain number of times (e.g., 10,000 times) for each core. The cores pass the semaphore back and forth until each core has owned it the desired number of times. With such benchmarks, once a given core has accessed the shared resource the desired number of times, it will stop requesting the semaphore until every core has owned the semaphore for the desired number of times. Once all the cores have owned the semaphore (i.e., accessed the shared resource) the desired number of times, the benchmark test may be complete or all cores may reset their counters and begin the process again.

If passing of the semaphore is relatively even, parallel processing is increased as a given core can perform processing based on the use of the limited resource while other cores are accessing that limited resource.

With conventional approaches to semaphore release and passing, however, the passing of the semaphore can be drastically uneven. Broadly, the “release” of a semaphore refers to a process of “giving up” the semaphore by an entity (e.g., a core) holding the semaphore, so that other entities (e.g., other cores) can obtain the semaphore and thereby obtain exclusive access to the resource controlled by the semaphore. With conventional approaches, an indication of the release of a semaphore can be received more quickly by the releasing core or a core that is geographically close to the releasing core from a processing and/or physical system architecture standpoint. As a result, workloads that share a semaphore between multiple cores can observe poor fairness because cores near the first core to win the semaphore acquire the semaphore disproportionately often due to their geographical proximity to the core that releases the semaphore. A set of nearby cores (often a pair of adjacent cores or a quartet of adjacent cores) can keep the semaphore until they have accessed a shared resource the maximum number of times at which time the semaphore passes to another pair of cores that repeat the process. In this way, access to the shared resource is not shared evenly.

In accordance with the described techniques, this problem is mitigated by releasing the semaphore from a core other than the current owner of the semaphore, thus changing the location of geographically advantaged cores. Such a system can be implemented in software, can be made an instruction set architecture (ISA) extension, and/or can be implemented in hardware.

By having a remote core in the system release the semaphore on behalf of the current owning core, the cache line for the semaphore is relocated to a different cache in the system and invalidated from all other caches. This operation provides the newly assigned releasing core and its neighbors an improved opportunity to acquire the core in the next iteration of the acquire/release sequence. The reassignment of the releasing core can be random or can follow a set pattern in different implementations.

In some aspects, the techniques described herein relate to a computing device including: a plurality of cores; one or more computing resources; and core selection circuitry configured to receive an indication that a first core from the plurality of cores has exclusive access to the one or more computing resources and configured to instruct a second core from the plurality of cores to release the exclusive access of the first core.

In some aspects, the techniques described herein relate to a computing device, wherein: the first core obtains exclusive access to the one or more computing resources by acquiring a semaphore, and the core selection circuitry is configured to instruct the second core to release the semaphore.

In some aspects, the techniques described herein relate to a computing device, wherein the first core acquires the semaphore by storing semaphore data in a cache memory.

In some aspects, the techniques described herein relate to a computing device, wherein the second core causes the semaphore data to be released from the cache memory.

In some aspects, the techniques described herein relate to a computing device, wherein the second core is randomly selected from the plurality of cores.

In some aspects, the techniques described herein relate to a computing device, wherein: the plurality of cores has an ordered arrangement, and the second core is a next one of the plurality of cores from the first core in the ordered arrangement.

In some aspects, the techniques described herein relate to a computing device, wherein: the plurality of cores has an ordered arrangement, and the second core is set to be one of the plurality of cores a prime number away from the first core in the ordered arrangement, the prime number being greater than 2.

In some aspects, the techniques described herein relate to a computing device, wherein the core selection circuitry is further configured to: receive an indication of a read/write request from the first core with respect to the one or more computing resources; receive additional indications that each of the plurality of cores stores a shared copy of data corresponding to the read/write request; and instruct the second core to release the exclusive access based on each of the plurality of cores storing the shared copy of data corresponding to the read/write request.

In some aspects, the techniques described herein relate to a computing device, wherein the one or more computing resources include a buffer.

In some aspects, the techniques described herein relate to a method including: receiving, at a cache memory, a store instruction from a first core of a plurality of cores, the received store instruction instructing that data be written into the cache memory; and based on the store instruction being a semaphore store instruction releasing a held semaphore, signaling a second core of the plurality of cores to perform the semaphore store instruction releasing the semaphore.

In some aspects, the techniques described herein relate to a method, wherein the second core is randomly selected from the plurality of cores.

In some aspects, the techniques described herein relate to a method, wherein: the plurality of cores has an ordered arrangement, and the second core is a next one of the plurality of cores from the first core in the ordered arrangement.

In some aspects, the techniques described herein relate to a method, wherein: the plurality of cores has an ordered arrangement, and the second core is set to be one of the plurality of cores a prime number away from the first core in the ordered arrangement, the prime number being greater than 2.

In some aspects, the techniques described herein relate to a method, further including determining that the received store instruction is the semaphore store by: identifying that the received store instruction from the first core corresponds to one or more shared computing resources; and identifying that each of the plurality of cores has a shared copy of data corresponding to the received store instruction.

In some aspects, the techniques described herein relate to a method, wherein determining that the received store instruction is the semaphore store instruction is performed by core selection circuitry associated with the cache memory.

In some aspects, the techniques described herein relate to a method, wherein determining that the received store instruction is the semaphore store instruction is performed by program code stored in a computer memory that is executed by a processor.

In some aspects, the techniques described herein relate to a computer system configured for controlling operation of a plurality of cores, a shared computing resource, and at least one cache memory, the computer system including: a memory configured to store data and instructions; and a processor communicatively coupled to the memory and operable to: receive a store instruction from a first core of the plurality of cores at the at least one cache memory, the received store instruction instructing that data be written into the at least one cache memory; based on the store instruction being a semaphore store instruction releasing a held semaphore, signaling a second core of the plurality of cores to perform the semaphore store instruction releasing the held semaphore; and causing the second core to release the held semaphore from the first core.

In some aspects, the techniques described herein relate to a computer system, wherein the second core is randomly selected from a plurality of cores.

In some aspects, the techniques described herein relate to a computer system, wherein the second core is different from the first core.

In some aspects, the techniques described herein relate to a computer system, wherein at least the first core and the second core of the plurality of cores request access to the shared computing resource while processing one or more tasks substantially in parallel.

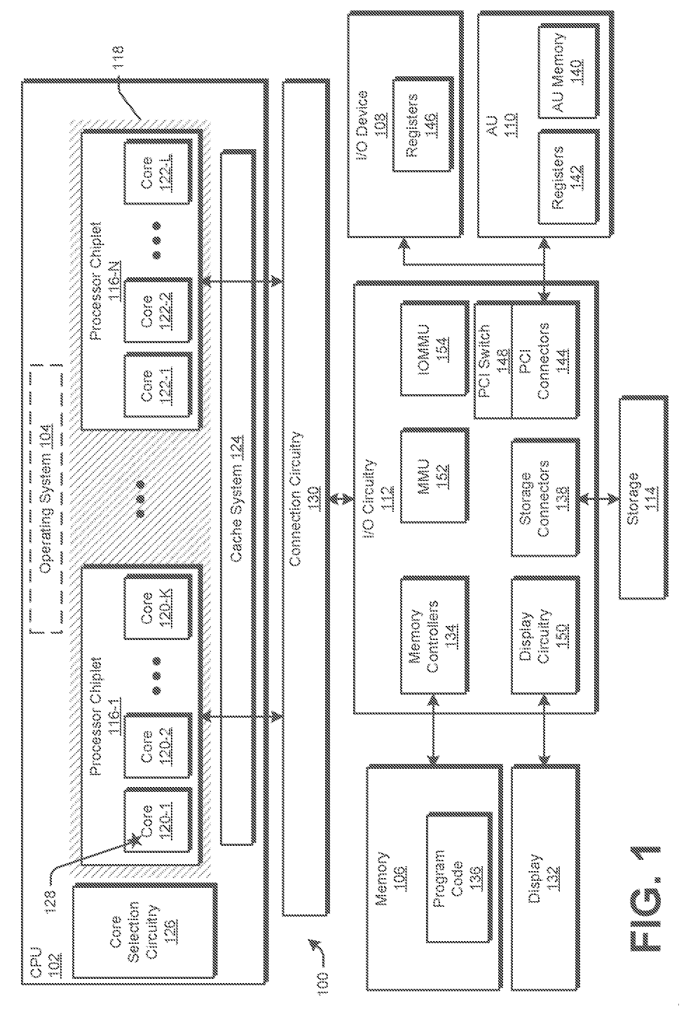

FIG. 1 is a block diagram of a processing system configured to execute one or more applications, in accordance with one or more implementations.

FIG. 1 includes a processing system 100 configured to execute one or more applications, such as compute applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 100 includes a central processing unit (CPU) 102. In one or more implementations, the CPU 102 is configured to run an operating system (OS) 104 that manages the execution of applications. For example, the OS 104 is configured to schedule the execution of tasks (e.g., instructions) for applications, allocate portions of resources (e.g., system memory 106, CPU 102, input/output (I/O) device 108, accelerator unit (AU) 110, storage 114) for the execution of tasks for the applications, provide an interface to I/O devices (e.g., I/O device 108) for the applications, or any combination thereof.

The CPU 102 includes one or more processor chiplets 116, which are communicatively coupled together by a data fabric 118 in one or more implementations.

Each of the processor chiplets 116, for example, includes one or more processor cores 120, 122 configured to concurrently execute one or more series of instructions, also referred to herein as “threads,” for an application. Although the one or more processor cores 120, 122 are included as part of respective chiplets in the illustrated example, in one or more implementations, the described techniques are implemented using clusters of cores 120,122, which are not necessarily partitioned on separate chiplets per cluster. Further, the data fabric 118 communicatively couples each processor chiplet 116-N of the CPU 102 such that each processor core (e.g., processor cores 120) of a first processor chiplet (e.g., 116-1) is communicatively coupled to each processor core (e.g., processor cores 122) of one or more other processor chiplets 116. Though the example embodiment presented in FIG. 1 shows a first processor chiplet (116-1) having three processor cores (120-1, 120-2, 120-K) representing a K number of processor cores 122 and a second processor chiplet (116-N) having three processor cores (e.g., 122-1, 122-2, 122-L) representing an L number of processor cores 122, in other implementations (L being an integer number greater than or equal to one), each processor chiplet 116 may have any number of processor cores 120, 122. For example, each processor chiplet 116 can have the same number of processor cores 120, 122 as one or more other processor chiplets 116, a different number of processor cores 120, 122 as one or more other processor chiplets 116, or both.

Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

In this example, the system 100 includes a cache system 124, which is implementable according to a cache hierarchy. Although the cache system 124 is depicted in the CPU 102, in one or more implementations, the cache system is additionally implemented in other components such as with the memory 106. Alternatively, a cache system is implemented completely outside of the CPU 102, such as by using the memory 106 and/or the AU 110. In at least one implementation, the cache system 124 includes one or more of an instruction cache, a data cache, shared cache(s), and system memory (e.g., the memory 106), for example, arranged in a hierarchy based on the respective sizes and/or other characteristics of the caches. As an example, based on such a cache hierarchy, a core 120, 122 first requests data from a controller of a corresponding data cache (e.g., an L1 cache). Based on the data not being in the data cache, the data cache may request the data from a cache at the next level of the cache hierarchy, which may be a shared cache. The caches then continue in this way until the data is found in a cache or requested from the system memory (e.g., the memory 106), at which point, the data is returned to the core 120, 122.

In accordance with the described techniques, the CPU 102 includes core selection circuitry 126. In variations, however, the core selection circuitry 126 can be included in and/or implemented by one or more different components of the processing system 100, such as the memory 106, the I/O device 108, the AU 110, the I/O circuitry 112, the storage 114, and so forth. In at least one implementation, the core selection circuitry 126 or portions of the core selection circuitry 126 are included in at least two of the depicted components of the processing system 100. By way of example, the core selection circuitry 126 may be included in or otherwise implemented by at least the memory 106 and the CPU 102 and/or by at least the memory 106 and the AU 110.

In one or more implementations, the core selection circuitry 126 is circuitry (e.g., resistors, capacitors, transistors, connectors, and so on) incorporated within and/or on silicon and arranged in a particular logical layout to perform the operations described herein. In accordance with the described techniques, for instance, the core selection circuitry 126 is configured to monitor read/write operations performed with respect to system computing resources, such as shared cache(s), instruction cache, and data cache to determine whether such read/write operations are associated with a semaphore. When a core 120, 122 receives instructions to release data that the core selection circuitry 126 has identified as a semaphore 128 (either via the CPU 102 or the program code 136), it provides instructions to a core 120, 122 different than the core 120, 122 associated with the shared cache(s), the instruction cache, and the data cache to perform the read/write operation that releases the semaphore 128.

In accordance with the described techniques, the semaphore 128 is a synchronization mechanism used to control access to shared resources by multiple processes, threads, and/or cores, such as in a concurrent execution environment. The semaphore 128 is configured to help avoid conflicts or race conditions when multiple threads, processes, and/or cores attempt to access shared resources substantially simultaneously. Examples types of semaphores include counting semaphores, which allow an arbitrary resource count, and binary semaphores, which are restricted to the values of 0 and 1 (or locked/unlocked, unavailable/available, or similar). In one or more implementations, the semaphore 128 is implemented using a variable or abstract data type in software, such as for a multi-tasking operating system. For instance, a locking variable may be used to control access to the semaphore 128, and the locking variable may be manipulated using a test-and-set-lock command.

A computing resource to which a semaphore 128 controls access can be any of a variety of software or firmware implemented mechanisms (e.g., data or data structures) or hardware components that multiple cores, processes, and/or threads compete for during parallel computing and/or during multi-tasking operations. Examples of such shared computing resources include but are not limited to buffers, hardware interfaces (e.g., networking interfaces), communication channels, and so forth. It is to be appreciated that the computing resources shared by multiple processes, threads, and/or cores and to which semaphores control access during substantially parallel computing may include various other resources in accordance with the described techniques.

Additionally, within the processing system 100, the CPU 102 is communicatively coupled to an I/O circuitry 112 by a connection circuitry 130. For example, each processor chiplet 116 of the CPU 102 is communicatively coupled to the I/O circuitry 112 by the connection circuitry 130. The connection circuitry 130 includes, for example, one or more data fabrics, buses, buffers, queues, and the like. The I/O circuitry 112 is configured to facilitate communications between two or more components of the processing system 100 such as between the CPU 102, system memory 106, display 132, universal serial bus (USB) devices, peripheral component interconnect (PCI) devices (e.g., I/O device 108, AU 110), storage 114, and the like.

As an example, system memory 106 includes any combination of one or more volatile memories and/or one or more non-volatile memories, examples of which include dynamic random-access memory (DRAM), static random-access memory (SRAM), non-volatile RAM, and the like. To manage access to the system memory 106 by CPU 102, the I/O device 108, the AU 110, and/or any other components, the I/O circuitry 112 includes one or more memory controllers 134. These memory controllers 134, for example, include circuitry configured to manage and fulfill memory access requests issued from the CPU 102, the I/O device 108, the AU 110, or any combination thereof. Examples of such requests include read requests, write requests, fetch requests, pre-fetch requests, or any combination thereof. That is to say, these memory controllers 134 are configured to manage access to the data stored at one or more memory addresses within the system memory 106, such as by CPU 102, the I/O device 108, and/or the AU 110.

When an application is to be executed by processing system 100, the OS 104 running on the CPU 102 is configured to load at least a portion of program code 136 (e.g., an executable file) associated with the application from, for example, a storage 114 into system memory 106. This storage 114, for example, includes a non-volatile storage such as a flash memory, solid-state memory, hard disk, optical disc, or the like configured to store program code 136 for one or more applications.

To facilitate communication between the storage 114 and other components of processing system 100, the I/O circuitry 112 includes one or more storage connectors 138 (e.g., universal serial bus (USB) connectors, serial AT attachment (SATA) connectors, PCI Express (PCIe) connectors) configured to communicatively couple storage 114 to the I/O circuitry 112 such that I/O circuitry 112 is capable of routing signals to and from the storage 114 to one or more other components of the processing system 100.

In association with executing an application, in one or more scenarios, the CPU 102 is configured to issue one or more instructions (e.g., threads) to be executed for an application to the AU 110. The AU 110 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 110 includes one or more compute units that concurrently execute one or more threads of an application and store data resulting from the execution of these threads in AU memory 140. This AU memory 140, for example, includes any combination of one or more volatile memories and/or non-volatile memories, examples of which include caches, video RAM (VRAM), or the like. In one or more implementations, these compute units are also configured to execute these threads based on the data stored in one or more physical registers 142 of the AU 110.

To facilitate communication between the AU 110 and one or more other components of processing system 100, the I/O circuitry 112 includes or is otherwise connected to one or more connectors, such as PCI connectors 144 (e.g., PCIe connectors) each including circuitry configured to communicatively couple the AU 110 to the I/O circuitry such that the I/O circuitry 112 is capable of routing signals to and from the AU 110 to one or more other components of the processing system 100. Further, the PCIe connectors 144 are configured to communicatively couple the I/O device 108 to the I/O circuitry 112 such that the I/O circuitry 112 is capable of routing signals to and from the I/O device 108 to one or more other components of the processing system 100.

By way of example and not limitation, the I/O device 108 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 108 is configured to execute one or more operations, tasks, instructions, or any combination thereof based on one or more physical registers 146 of the I/O device 108. In one or more implementations, such physical registers 146 are configured to maintain data (e.g., operands, instructions, values, variables) indicating one or more operations, tasks, or instructions to be performed by the I/O device 108.

To manage communication between components of the processing system 100 (e.g., AU 110, I/O device 108) that are connected to PCI connectors 144, and one or more other components of the processing system 100, the I/O circuitry 112 includes PCI switch 148. The PCI switch 148, for example, includes circuitry configured to route packets to and from the components of the processing system 100 connected to the PCI connectors 144 as well as to the other components of the processing system 100. As an example, based on address data indicated in a packet received from a first component (e.g., CPU 102), the PCI switch 148 routes the packet to a corresponding component (e.g., AU 110) connected to the PCI connectors 144.

Based on the processing system 100 executing a graphics application, for instance, the CPU 102, the AU 110, or both are configured to execute one or more instructions (e.g., draw calls) such that a scene including one or more graphics objects is rendered. After rendering such a scene, the processing system 100 stores the scene in the storage 114, displays the scene on the display 132, or both. The display 132, for example, includes a cathode-ray tube (CRT) display, liquid crystal display (LCD), light emitting diode (LED) display, organic light emitting diode (OLED) display, or any combination thereof. To enable the processing system 100 to display a scene on the display 132, the I/O circuitry 112 includes display circuitry 150. The display circuitry 150, for example, includes high-definition multimedia interface (HDMI) connectors, DisplayPort connectors, digital visual interface (DVI) connectors, USB connectors, and the like, each including circuitry configured to communicatively couple the display 132 to the I/O circuitry 112. Additionally or alternatively, the display circuitry 150 includes circuitry configured to manage the display of one or more scenes on the display 132 such as display controllers, buffers, memory, or any combination thereof.

Further, the CPU 102, the AU 110, or both are configured to concurrently run one or more virtual machines (VMs), which are each configured to execute one or more corresponding applications. To manage communications between such VMs and the underlying resources of the processing system 100, such as any one or more components of processing system 100, including the CPU 102, the I/O device 108, the AU 110, and the system memory 106, the I/O circuitry 112 includes memory management unit (MMU) 152 and input-output memory management unit (IOMMU) 154. Alternatively or additionally, each core 120, 122 includes a respective MMU 152, e.g., one MMU per core. The MMU 152 includes, for example, circuitry configured to manage memory requests, such as from the CPU 102 to the system memory 106. For example, the MMU 152 is configured to handle memory requests issued from the CPU 102 and associated with a VM running on the CPU 102. These memory requests, for example, request access to read, write, fetch, or pre-fetch data residing at one or more virtual addresses (e.g., guest virtual addresses) each indicating one or more portions (e.g., physical memory addresses) of the system memory 106. Based on receiving a memory request from the CPU 102, the MMU 152 is configured to translate the virtual address indicated in the memory request to a physical address in the system memory 106 and to fulfill the request. The IOMMU 154 includes, for example, circuitry configured to manage memory requests (memory-mapped I/O (MMIO) requests) from the CPU 102 to the I/O device 108, the AU 110, or both, and to manage memory requests (direct memory access (DMA) requests) from the I/O device 108 or the AU 110 to the system memory 106. For example, to access the registers 146 of the I/O device 108, the registers 142 of the AU 110, and/or the AU memory 140, the CPU 102 issues one or more MMIO requests. Such MMIO requests each request access to read, write, fetch, or pre-fetch data residing at one or more virtual addresses (e.g., guest virtual addresses) which each represent at least a portion of the registers 146 of the I/O device 108, the registers 142 of the AU 110, or the AU memory 140, respectively. As another example, to access the system memory 106 without using the CPU 102, the I/O device 108, the AU 110, or both are configured to issue one or more DMA requests. Such DMA requests each request access to read, write, fetch, or pre-fetch data residing at one or more virtual addresses (e.g., device virtual addresses) which each represent at least a portion of the system memory 106. Based on receiving an MMIO request or DMA request, the IOMMU 154 is configured to translate the virtual address indicated in the MMIO or DMA request to a physical address and fulfill the request.

In variations, the processing system 100 can include any combination of the components depicted and described. For example, in at least one variation, the processing system 100 does not include one or more of the components depicted and described in relation to FIG. 1. Additionally or alternatively, in at least one variation, the processing system 100 includes additional and/or different components from those depicted. The system 100 is configurable in a variety of ways with different combinations of components in accordance with the described techniques.

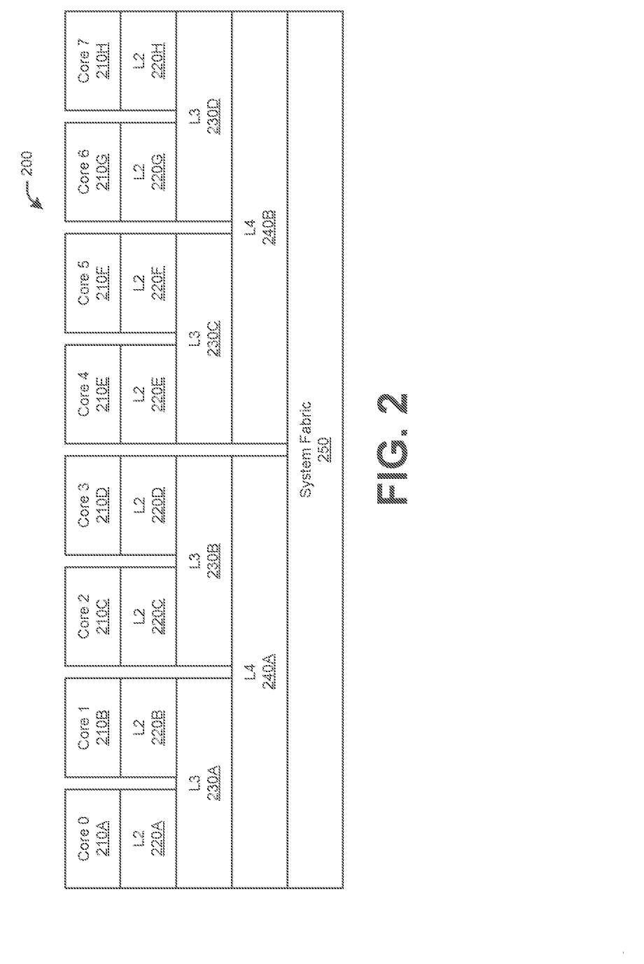

FIG. 2 is a diagram 200 of a cache arrangement of the cores of a processing system, in accordance with one or more implementations.

FIG. 2 includes first through eighth cores 210A-210H, first through eighth level two (L2) caches 220A-220H, first through fourth level three (L3) caches 230A-230D, first and second level four (L4) caches 240A and 240B, and a system fabric 250. For ease of disclosure, the cores 210A-210H may be referred to generically as cores 210, the L2 caches 220A-220H may be referred to generically as L2 caches 220, the L3 caches 230A-230D may be referred to generically as L3 caches 230, and the L4 caches 240A and 240B may be referred to generically as L4 caches 240. The cores 210 are examples of the cores 120, 122, and the system fabric 250 is an example of the data fabric 118 and/or the connection circuitry 130. In one or more implementations, the L2 caches 220, the L3 caches 230, and the L4 caches are examples of at least a portion of the cache system 124.

In this example, each of the first through eighth cores 210A-210H is associated with an L2 cache 220, an L3 cache 230, an L4 cache 240, and the system fabric 250 in order. A single one of the first through eighth cores 210A-210H is associated with each L2 cache 220; two adjacent ones of the first through eighth cores 210A-210H are associated with each L3 cache 230; four adjacent ones of the first through eighth cores 210A-210H are associated with each L4 cache 230; and all of the first through eighth cores 210A-210H are associated with the system fabric 250.

Although not shown, each of the first through eighth cores 210A-210H can be associated with a level zero (L0) and/or level one (L1) cache that is integral to the respective one of the first through eighth cores 210A-210H and/or an associated L2 cache 220.

Caches 220, 230, 240 are used to store instructions or data that are frequently used by the cores. Typically, relatively lower-level caches are faster and smaller than relatively higher-level caches, e.g., an L1 cache is a lower-level cache than an L2 cache, an L2 cache is a lower-level cache than an L3 cache, and so forth. The caches 220, 230, 240 allow the cores 210 to access frequently used instructions or data using quicker memories, which allows for faster operating speeds. Instructions or data that are used most frequently are stored in the relatively lower-level caches, with less frequently used instructions or data being stored in the relatively higher-level caches, the system fabric, or even in storage 114.

Furthermore, the shared caches (the L3 cache 230 and the L4 cache 240 in this example) can store instructions or data that may be used by multiple cores 210. For example the L3 cache 230A, which is shared by the first core 210A and the second core 210B, can store instructions or data that may be used by the first core 210A and the second core 210B. Likewise, the L4 cache 240B, which is shared by the fifth through eighth cores 210E-210H, can store instructions or data that may be used by the fifth through eighth cores 210E-210H.

Writing data to a given cache 220, 230, 240 can require the use of buffers, e.g., in the connection circuitry 130. These buffers can be a limited resource in the processing system, meaning that the cores 210 have to share them among themselves. A semaphore 128 can be used to indicate that a core 210 is currently allocated access to the buffers. An indication of ownership of this semaphore 128 can be stored in one of the caches 220, 230, 240 associated with the respective core, in the system fabric 250, or even in the storage 114.

When the core 210 that owns the semaphore 128 is finished with the use of the buffers in the connection circuitry 130, the semaphore 128 will be released, allowing another core 210 to request ownership of the semaphore 128 and access to the buffers in the connection circuitry 130. With conventional approaches, this may be done by having the owning core 210 execute a semaphore store command in the cache 220, 230, 240 where the semaphore is stored, indicating that the semaphore is being released. In such a case, the first core 210 that successfully sends a new request for ownership of the semaphore will be granted ownership of the semaphore.

Generally, every core 210 attempting to utilize the limited resource regulated by the semaphore 128 will request ownership of the semaphore 128 to gain access to the limited resource. Since each core is geographically and computationally separated from the current owner of the semaphore 128, it will take a different amount of time for each of the cores 210 to be notified that the semaphore 128 has been released and also for their requests to be communicated to an arbitrator. This delay gives an advantage in acquiring the semaphore 128 to cores 210 closer to the core 210 releasing the semaphore.

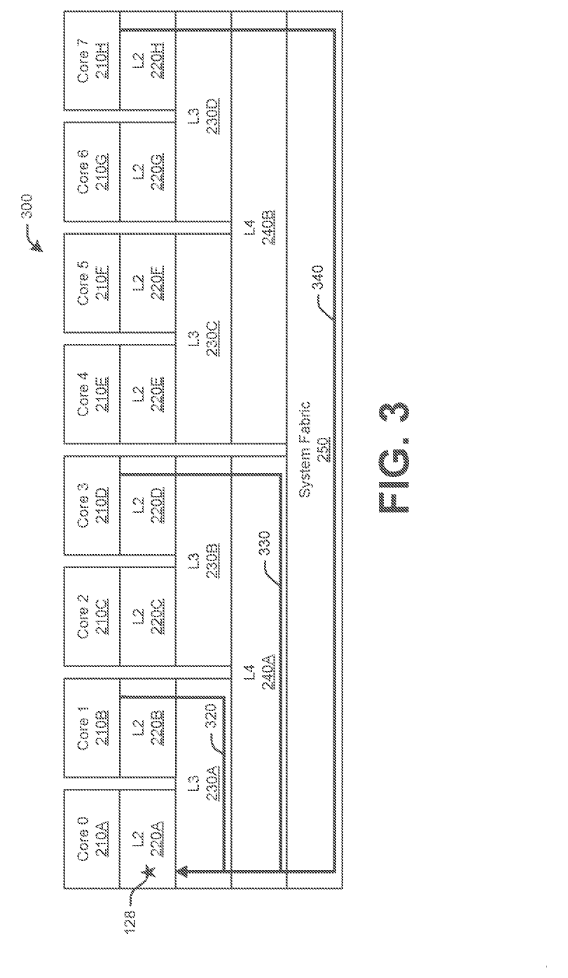

FIG. 3 is a diagram 300 of a cache arrangement of the cores of a processing system illustrating how acquiring a semaphore can be imbalanced. Elements in FIG. 3 that are the same as those in FIG. 2 operate as described above and their description will not be repeated.

In the example of FIG. 3, the first core 210A is the current owner of the semaphore 128, which is stored in L2 cache 220A, which is associated with the first core 210A. When the first core 210A broadcasts or otherwise communicates that the semaphore 128 is released, such as by executing the proper store command in the L2 cache 220A, all the cores 210 experience a delay in identifying that the semaphore has been released. An amount of delay experienced by a particular core 210 depends upon the cache structure.

In the implementation of FIG. 3, the first core 210A is directly connected to the L2 cache 220A and so observes the semaphore release with latency N. The second core 210B observes the semaphore release through the L3 cache 230A it shares with the first core 210A with a latency 2N. The third and fourth cores 210C and 210D observe the semaphore release through the L4 cache 240A they share with the first and second cores 210A and 210B with a latency 4N. The fifth through eighth cores 210E-210H observe the semaphore release through the system fabric 250 shared by all the cores 210 with a latency 8N.

FIG. 3 shows this by way of example, illustrating the latencies that the first core 210A, the second core 210B, the fourth core 210D, and the eighth core 210H experience in identifying release of the semaphore 128.

The first core 210A is connected to the L2 cache 220A that announces the release of the semaphore 128. It need only read that information from the adjacent L2 cache 220A and so it has a path length of 1 and a resulting latency of N.

The second core 210B is connected to the L2 cache 220A that announces the release of the semaphore via the L3 cache 230A shared by the first and second cores 210A and 210B. The notification path 320 of the semaphore release to the second core 210B must pass through the L3 cache 230A and so has a path length of 2 and a resulting latency of 2N.

The fourth core 210D is connected to the L2 cache 220A that announces the release of the semaphore via the L4 cache 240A shared by the first through fourth cores 210A-210D. The notification path 330 of the semaphore release to the fourth core 210D must pass through the L4 cache 240A and so has a path length of 4 and a resulting latency of 4N.

The eighth core 210H is connected to the L2 cache 220A that announces the release of the semaphore via the system fabric 250 shared by all the cores 210A-210H. The notification path 340 of the semaphore release to the eighth core 210H must pass through the system fabric 250 and so has a path length of 8 and a resulting latency of 8N.

Although not shown, notification paths for the third, fifth, sixth, and seventh cores 210C, 210E, 210F, and 210G can be determined in a similar manner to that shown above.

As shown in FIG. 3, when the first core 210A releases the semaphore 128, the first core 210A and the second core 210B have the shortest latency times. As a result, they will have the best chance to reclaim the released semaphore 128 since their requests for the semaphore 128 can be sent (and thus received) sooner than semaphore requests from the other cores 210C-210H.

As a result of this unequal path length in observing a semaphore release, and thus requesting and acquiring the semaphore, unfairness in acquisition patterns can result if the owning core 210 is always the releasing core. In this case, semaphore ownership can remain with a single core 210 or pass between geographically proximate cores 210, when the semaphore is requested by many cores substantially simultaneously, e.g., when multiple cores are used for parallel processing. This can lead to cores that are remote from a semaphore-owning core experiencing disproportionate amounts of latency during parallel processing (and timing out), because those geographically remote cores are disadvantaged for obtaining control of the semaphore 128. Under conventional approaches, only when a current owner or owner pair temporarily discontinues its need of the semaphore 128 does ownership of the semaphore 128 pass to another core 210 or pair of cores 210.

Although FIGS. 2 and 3 discuss the allocation of ownership of a semaphore 128 for accessing buffers in the connection circuitry 130, this is by way of example only. Alternate implementations use the semaphore 128 to facilitate sharing of any limited resource in the computing system 100 that is shared among the cores 210.

In many cases, it is desirable to have the use of limited shared resources spread out more evenly across the cores 210. For example, if the limited resource is a buffer, it can be desirable to allow one core 210 to use a buffer to fill some cache with instructions or data and then to process those instructions or data while another core 210 uses the shared buffers to store its own instructions or data in a different cache.

In accordance with the described techniques, the system 100 achieves this by changing the core 210 that releases the semaphore from the core 210 that currently owns the semaphore to a different core 210. Since the delay in identifying a release is based on the computational and/or physical, geographical distance between the releasing core 210 and the monitoring core 210, changing the releasing core 210 each time the semaphore is released can even out semaphore request latency over time for the cores 210 attempting to access the resource and can thereby even out the ownership of the semaphore 128.

For example, as shown in FIGS. 2 and 3, if the first core 210A both owned and released the semaphore 128, the first and second cores 210A and 210B would have a significant advantage in regaining the semaphore 128 after release. However, if the first core 210A owns the semaphore 128 and the sixth core 210F releases the semaphore, the fifth and sixth cores 210E and 210F have a significant advantage in regaining the semaphore after release. In this way the first and second cores 210A and 210B can be prevented from continually maintaining the semaphore.

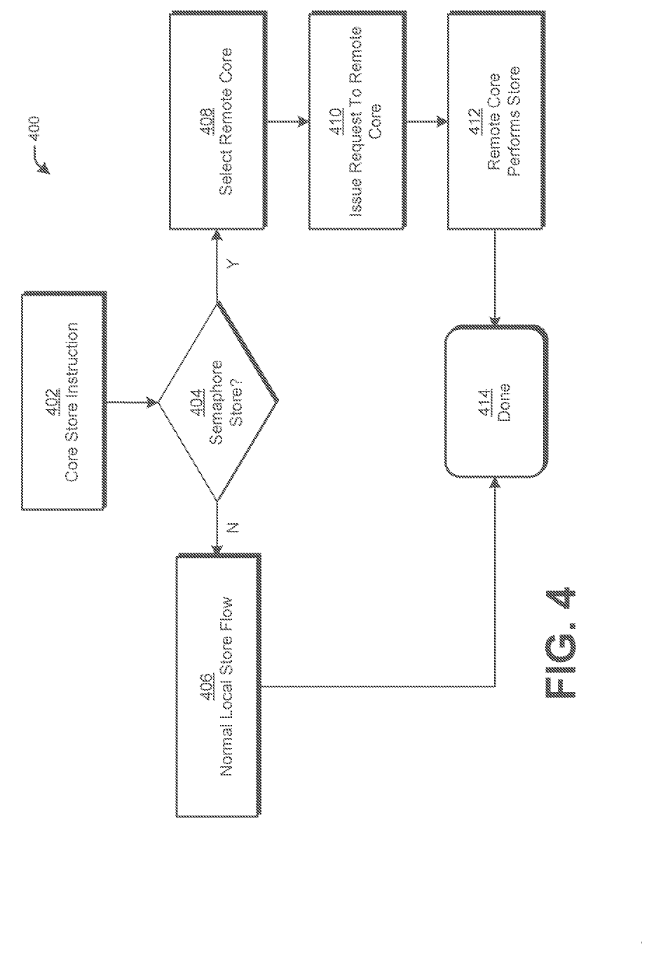

FIG. 4 is a flow chart 400 showing how a semaphore release is detected and a remote releasing core is selected, in accordance with one or more implementations.

As shown in FIG. 4, this operation begins when a core 210 issues a store instruction 402. This store instruction could be a normal store instruction or a semaphore store instruction indicating that an owned semaphore should be released.

The system then determines whether a store is a semaphore store 404 based on multiple caches (e.g., every cache of the CPU) storing a shared copy of the semaphore data. In one or more implementations, the store is associated with an address to store data, the system reads this data address and determines whether all the caches store a shared copy of the semaphore data at the data address. If the data stored at the data address is shared by multiple caches (e.g., all of them), then the store is determined to be a semaphore store 404. If the data stored at the data address is exclusive to a particular cache, then the store is determined not to be a semaphore store 404. There are different ways that this can be achieved. In one implementation, program code 136 could check whether cores 210 other than the core 210 executing the store also have a shared copy of the semaphore data. In the case of a normal store instruction, only the core 210 that issued the store instruction would have a copy of the data being stored. In contrast, in the case of a semaphore store, all the cores 210 would have a shared copy of the semaphore data since all the cores 210 will typically want to be granted the semaphore.

In this implementation, if the system determines that the data associated with a received store instruction is not shared in every other core 210, then it is determined that the received store instruction is a standard store instruction and not a semaphore store instruction. Contrarily, if the system determines that the data associated with the received store instruction is shared in every other core 210, then it is determined that the received store instruction is a semaphore store instruction.

If the system determines that the received store instruction is not a semaphore store instruction (output N in 404), the operation proceeds with normal local store flow for the store instruction 406. The store instruction is processed by the core 210 that issued it using the normal procedures for processing a store instruction.

If the system determines that the received store instruction is a semaphore store instruction (output Y in 404), the operation proceeds by selecting a remote core 210 that is different from the core 210 that issued the store instruction 408. The details of this selection process can vary in different implementations. In one or more implementations, hardware of the system detects whether the store is a releasing store, e.g., a semaphore store instruction. In one or more such implementations, software requests a different core in the system release the semaphore 128 than the core having possession of the semaphore. Alternatively or additionally, the system may implement a new type of instructions, e.g., indicating that a given store instruction is a semaphore releasing store. In other words, the new type of instruction would be an extension to an instruction set architecture (ISA). Accordingly, such an instruction type is configured to signal to a cache hierarchy to select a releasing core 210 from among available cores 210 that are different from a core with possession of the semaphore.

In some implementations, the core selection circuitry 126 randomly selects the releasing core 210 from among the available cores 210. This random selection may be from all the cores 210, including the core 210 currently holding the semaphore, or could alternatively be from all the cores 210 except for the core 210 currently holding the semaphore. Although this may result in the selection of a releasing core 210 proximate to the core 210 currently holding the semaphore, the randomness of the selection process should prevent that from happening regularly, thus evening out the cores 210 from which the semaphore is released.

In other implementations, the core selection circuitry 126 sets the releasing core 210 to be a core 210 offset by a certain amount in the ordered arrangement of the cores 210. This could be as simple as the core selection circuitry 126 setting the releasing core 210 to be the next core 210 from the core 210 holding the semaphore in the ordered arrangement, e.g., incrementally cycling through the cores competing for the semaphore 128. For example, if the implementation has eight cores 210 competing for the semaphore 128 and the core 210 holding the semaphore is the third core 210, the system could set the releasing core to be the fourth core 210.

Alternatively, the core selection circuitry 126 selects the releasing core 210 to be a core 210 that is a prime number of cores away from the from the core 210 holding the semaphore in the ordered arrangement. For example, if the implementation has sixteen cores 210, the selected prime number is five, and the core 210 holding the semaphore is the seventh core 210, the system could set the releasing core to be the twelfth core 210.

When the core selection circuitry 126 sets the releasing core 210 based on an offset from the core 210 holding the semaphore, in at least one variation, the counting wraps around to the first core 210 when it reaches the last core 210. For example, in a scenario where the system has sixteen cores 210, the selected prime number is three, and the core 210 holding the semaphore is the fifteenth core 210, the core selection circuitry 126 can set the releasing core to be the second core 210.

The described ways of selecting the releasing core 210 are provided by way of example and should not be considered limiting. Other ways of selecting a releasing core 210 may be provided.

Once a remote core 210 is selected to become the releasing core 210, the core selection circuitry 126 causes a request to be issued to the selected remote core 210 to issue the semaphore release 410.

In response to this request, the selected remote core 210 performs a store operation for releasing the semaphore 412. This allows all the cores 210 competing for the semaphore 128 to request the semaphore 128 without necessarily granting the original holder of the semaphore or cores 210 proximate to the original holder an advantage.

Regardless of whether the received store instruction is a normal store instruction or a semaphore store instruction, once the instruction is processed (in 406 for a normal store instruction or in 412 for a semaphore store instruction), the operation is done 416. At this point processing can proceed with the cores 210 sending instructions to try and capture the released semaphore.

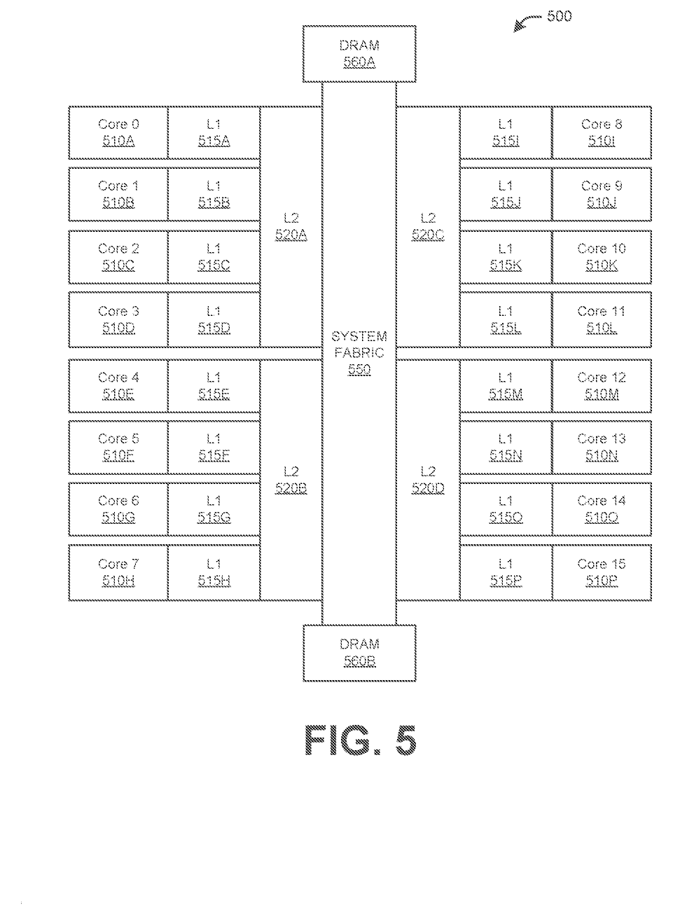

FIG. 5 is a diagram 500 of a cache arrangement of the cores of a processing system, in accordance with one or more implementations.

In this example, FIG. 5 includes first through sixteenth cores 510A-510P, first through sixteenth level one (L1) caches 515A-515P, first through fourth level two (L2) caches 520A-520D, a system fabric 550, and first and second DRAMs 560A and 560B. For ease of disclosure, the cores 510A-510P may be referred to generically as cores 510, the L1 caches 515A-515P may be referred to generically as L1 caches 515, the L2 caches 520A-520D may be referred to generically as L2 caches 520, and the first and second DRAMs 560A and 560B may be referred to generically as DRAMs 560.

Each of the first through sixteenth cores 510A-510P is associated with an L1 cache 515, an L2 cache 520, and the system fabric 550 in order. A single one of the first through sixteenth cores 510A-510P is associated with each L1 cache 515; four adjacent ones of the first through sixteenth cores 510A-510P are associated with each L2 cache 520; and all of the first through sixteenth cores 510A-510P are associated with the system fabric 550. The system fabric 550 is connected to the first and second DRAMs 560A and 560B to allow the cores 510 access to the DRAMs 560.

Although not shown, in at least one variation, each of the first through sixteenth cores 510A-510P is also associated with a level zero (L0) cache that is integral to the respective one of the first through sixteenth cores 510A-510P or an associated L1 cache 515.

The caches 515, 520 are configured and operate comparable to how the caches 220, 230, 240 operate with respect to the implementation in relation to FIG. 2. Given the connections of the cores 510 to the various caches 515, 520, the implementation of FIG. 5 runs a similar risk to that of the implementation of FIG. 2 of having an unfair distribution of the semaphore if the core 510 holding the semaphore is always the core 510 releasing the semaphore.

The implementation of FIG. 5 avoids this possibility by coordinating the release of the semaphore in a manner like that described in relation to FIG. 4, e.g., by the core selection circuitry 126. When a core 510 in this implementation has a semaphore and wishes to release that semaphore, the core selection circuitry 126 identifies the intent to release the semaphore by the core 510 currently holding the semaphore, determines a remote core 510 separate from the owning core 510 in some manner (e.g., randomly), and instructs the remote core 510 to order the release of the semaphore. In this way, the ownership of the semaphore is allocated more fairly and evenly across cores competing for a same limited resource.

The cache configurations of FIGS. 2 and 5 are provided by way of example only. Alternate implementations with differing numbers of cores, differing numbers and levels of cache, and different groupings of cores with caches can be provided in accordance with the described techniques.

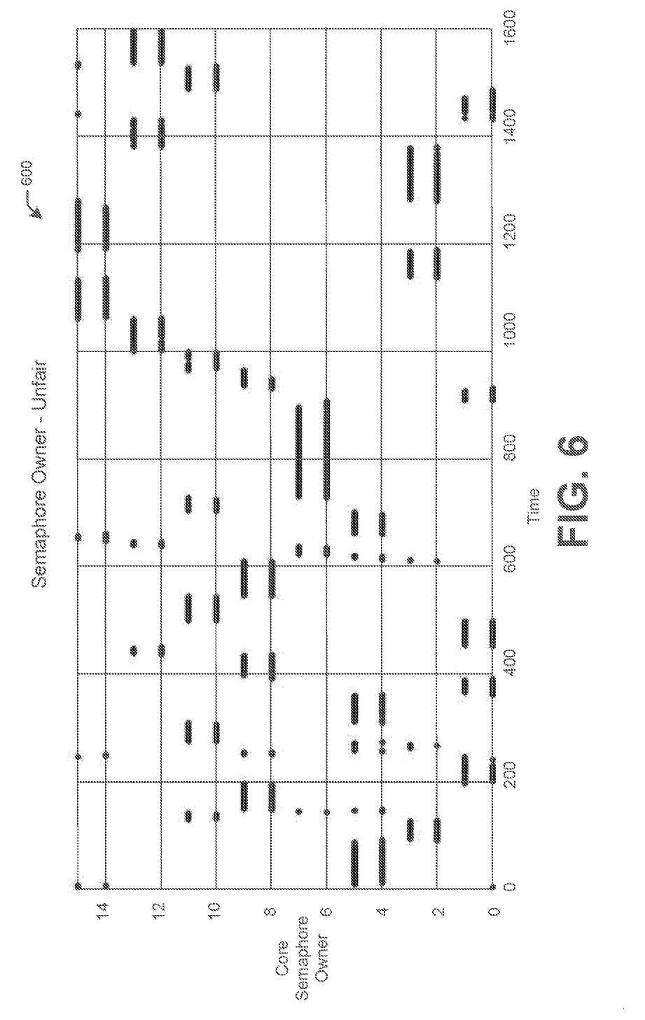

FIG. 6 is a graph 600 showing an example of acquisition of a semaphore in a computer system when a core holding a semaphore is allowed to release the semaphore. For ease of disclosure, this will be referred to as an “unfair” system.

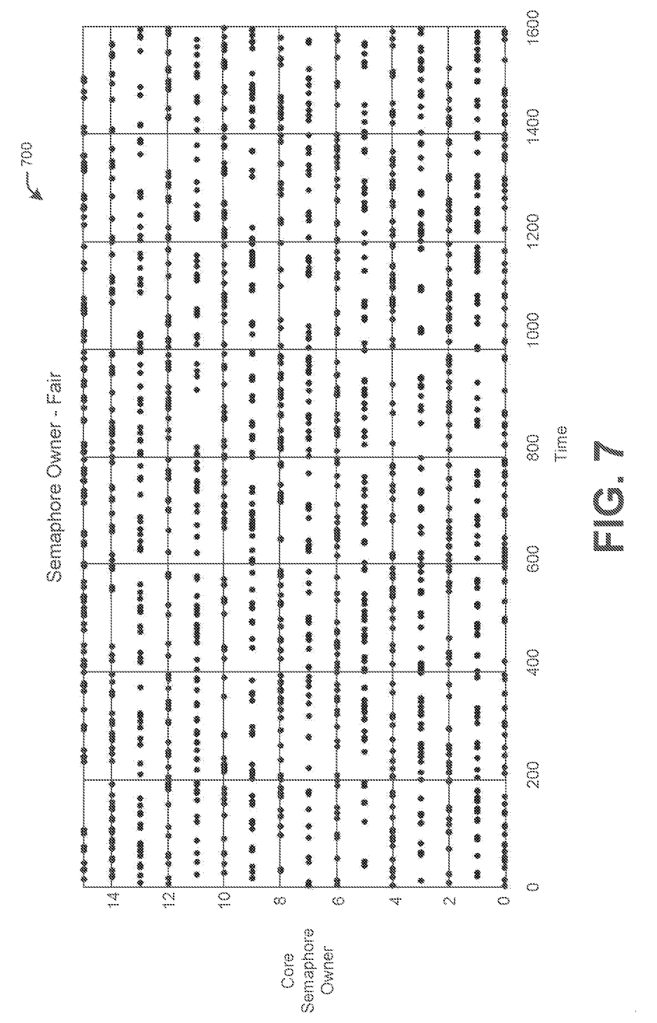

FIG. 7 is a graph 700 showing an example of acquisition of a semaphore in a computer system when a remote core different from the core holding the semaphore is selected to release the semaphore, in accordance with one or more implementations. For ease of disclosure, this will be referred to as an “fair” system.

In the analysis set forth in FIGS. 6 and 7, there are sixteen cores 510 and the number of times each core 510 must obtain the semaphore before temporarily going dormant is 100. The time axis in this graph represents unitless time periods during which the semaphore is released and reacquired. Since there are sixteen cores 510, each of which must acquire the semaphore one-hundred times, the graphs 600, 700 each measure 1600 time periods. At the end of these 1600 time periods, all the cores 510 will have acquired the semaphore one-hundred times. FIGS. 6 and 7 show the times during which the various cores 510 acquire their 100 semaphores in exemplary implementations.

The unfair implementation of FIG. 6 shows a bias in selecting a new core 510 to hold the semaphore when it is released. Specifically, this implementation favors the core 510 that was the immediately previous owner of the semaphore or neighbor cores 510 of the immediately previous owner of the semaphore.

As shown in FIG. 6, a single core 510 may retain the semaphore over tens or even a hundred consecutive time periods. Furthermore, when the semaphore passes to another core 510, it often passes to a core proximate to the core that released the semaphore.

In addition, early cores 510 that hold the semaphore may acquire the semaphore one-hundred times very quickly and go dormant for long stretches of the 1600 time periods. In the implementation of FIG. 6, the first core 510 to complete acquiring the semaphore one-hundred times does so at time 696, meaning that it goes dormant for over 900 time units.

In contrast, the fair implementation of FIG. 7 passes the semaphore 128 between the cores 510 in a relatively even manner. No one core 510 maintains the core for a significant time and when a core 510 releases the semaphore 128, there is no apparent tendency for the same core or a nearby core 510 to acquire the semaphore. Instead, the semaphore is distributed relatively randomly (and thus evenly). Furthermore, in the implementation of FIG. 7, the first core 510 to complete acquiring the semaphore one-hundred times does so at time 1505, meaning that it goes dormant for less than 100 time units.

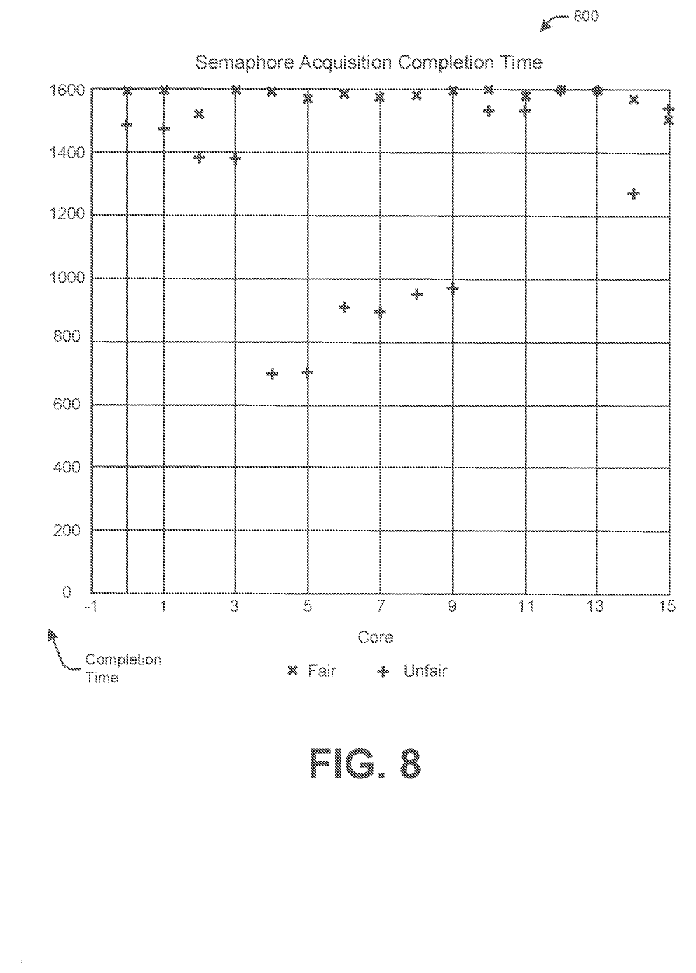

FIG. 8 is a graph showing when each core has acquired a semaphore a number of times in the implementations of FIGS. 6 and 7.

In FIG. 8 a plus sign (+) indicates when each core 510 in the unfair implementation of FIG. 6 acquires 100 semaphores and an X indicates when each core 510 in the fair implementation of FIG. 7 acquires 100 semaphores.

As shown in FIG. 8, in the unfair implementation demonstrated by FIG. 6, the fourth through ninth cores 510 all acquire the semaphore one-hundred times before the 1000^{th} time period, while the second, third, and fourteenth cores 510 all acquire the semaphore one-hundred times before the 1400^{th} time period. As a result, many cores 510 in the unfair implementation will be dormant for significant portions of the 1600 time periods allowed for all the cores 510 to acquire the semaphore one-hundred times.

In contrast, in the fair implementation demonstrated by FIG. 7, no core 510 acquires the semaphore one-hundred times before the 1500^{th} time period and most acquire their 100^{th} semaphore after the 1550^{th} time period. As a result, no core 510 in the fair implementation will be dormant for more than 100 time periods out of the 1600 time periods allowed for all of the cores 510 to acquire the semaphore one-hundred times, and most will be dormant for fewer than 50 time periods. This allows for a much more efficient use of the limited system resources and operation of the cores 510.

What is claimed is:

1. A computing device comprising:
a plurality of cores;
one or more computing resources; and
core selection circuitry configured to receive an indication that a first core from the plurality of cores has exclusive access to the one or more computing resources and configured to instruct a second core from the plurality of cores to release the exclusive access of the first core.

2. The computing device of claim 1, wherein:
the first core obtains exclusive access to the one or more computing resources by acquiring a semaphore, and
the core selection circuitry is configured to instruct the second core to release the semaphore.

3. The computing device of claim 2, wherein the first core acquires the semaphore by storing semaphore data in a cache memory.

4. The computing device of claim 3, wherein the second core causes the semaphore data to be released from the cache memory.

5. The computing device of claim 1, wherein the second core is randomly selected from the plurality of cores.

6. The computing device of claim 1, wherein:
the plurality of cores has an ordered arrangement, and
the second core is a next one of the plurality of cores from the first core in the ordered arrangement.

7. The computing device of claim 1, wherein:
the plurality of cores has an ordered arrangement, and
the second core is set to be one of the plurality of cores a prime number away from the first core in the ordered arrangement, the prime number being greater than 2.

8. The computing device of claim 1, wherein the core selection circuitry is further configured to:
receive an indication of a read/write request from the first core with respect to the one or more computing resources;
receive additional indications that each of the plurality of cores stores a shared copy of data corresponding to the read/write request; and
instruct the second core to release the exclusive access based on each of the plurality of cores storing the shared copy of data corresponding to the read/write request.

9. The computing device of claim 1, wherein the one or more computing resources include a buffer.

10. A method comprising:
receiving, at a cache memory, a store instruction from a first core of a plurality of cores, the received store instruction instructing that data be written into the cache memory; and
based on the store instruction being a semaphore store instruction releasing a held semaphore, signaling a second core of the plurality of cores to perform the semaphore store instruction releasing the semaphore.

11. The method of claim 10, wherein the second core is randomly selected from the plurality of cores.

12. The method of claim 10, wherein:
the plurality of cores has an ordered arrangement, and
the second core is a next one of the plurality of cores from the first core in the ordered arrangement.

13. The method of claim 10, wherein:
the plurality of cores has an ordered arrangement, and
the second core is set to be one of the plurality of cores a prime number away from the first core in the ordered arrangement, the prime number being greater than 2.

14. The method of claim 10, further comprising determining that the received store instruction is the semaphore store by:
identifying that the received store instruction from the first core corresponds to one or more shared computing resources; and
identifying that each of the plurality of cores has a shared copy of data corresponding to the received store instruction.

15. The method of claim 14, wherein determining that the received store instruction is the semaphore store instruction is performed by core selection circuitry associated with the cache memory.

16. The method of claim 14, wherein determining that the received store instruction is the semaphore store instruction is performed by program code stored in a computer memory that is executed by a processor.

17. A computer system configured for controlling operation of a plurality of cores, a shared computing resource, and at least one cache memory, the computer system comprising:
a memory configured to store data and instructions; and
a processor communicatively coupled to the memory and operable to:
receive a store instruction from a first core of the plurality of cores at the at least one cache memory, the received store instruction instructing that data be written into the at least one cache memory;
based on the store instruction being a semaphore store instruction releasing a held semaphore, signaling a second core of the plurality of cores to perform the semaphore store instruction releasing the held semaphore; and
causing the second core to release the held semaphore from the first core.

18. The computer system of claim 17, wherein the second core is randomly selected from a plurality of cores.

19. The computer system of claim 17, wherein the second core is different from the first core.

20. The computer system of claim 17, wherein at least the first core and the second core of the plurality of cores request access to the shared computing resource while processing one or more tasks substantially in parallel.
